(19) United States
(12) Patent Application Publication
(10) Pub. No.: US 2026/0024208 A1
(43) Pub. Date: Jan. 22, 2026

(54) METHOD AND SYSTEM OF BRAIN IMAGING DETECTION

(71) Applicant: Imvitec Corporation, Taipei City (TW)

(72) Inventors: Wen-Cheng CHANG, Taipei City (TW); Jing-Ming GUO, Taipei City (TW); Shu-Wei HUANG, Taipei City (TW)

(21) Appl. No.: 18/964,089

(22) Filed: Nov. 29, 2024

(30) Foreign Application Priority Data
Jul. 22, 2024 (TW) 113127381
Sep. 25, 2024 (TW) 113136485

(51) Int. Cl. G06T 7/00; G06T 3/40; G06T 3/60; G06T 7/13; G06T 7/136

(52) U.S. Cl. CPC G06T 7/0014; G06T 3/40; G06T 3/60; G06T 7/13; G06T 7/136; G06T 2200/04; G06T 2207/30016

(57) ABSTRACT

A method of brain imaging detection includes: dividing a brain image into a left brain medical image and a right brain medical image and obtaining the grayscale values of multiple pixels thereof, respectively; mirror-flipping one of the left and right brain medical images; performing a grayscale value subtraction with the mirror-flipped medical image and the other medical image to obtain a plurality of grayscale differences of the pixels; determining whether the grayscale difference of each pixel exceeds a grayscale difference threshold and whether a number of the pixels having the grayscale different exceeding the grayscale difference threshold is greater than or equal to a pixel number threshold; and when the number of the pixels having the grayscale difference exceeding the grayscale difference threshold is greater than or equal to the pixel number threshold, determining that the brain image is abnormal.

### CROSS REFERENCE TO RELATED APPLICATIONS

This Non-provisional application claims priority under 35 U.S.C. § 119(a) on Patent Application No(s). 113127381 filed in Taiwan, Republic of China on Jul. 22, 2024, and 113136485 filed in Taiwan, Republic of China on Sep. 25, 2024, the entire contents of which are hereby incorporated by reference.

### BACKGROUND

### Technology Field

The present disclosure relates to a detection method and, in particular, to a method and a system of brain imaging detection.

### Description of Related Art

MRI (Magnetic Resonance Imaging) is characterized by high image resolution and can clearly show subtle changes in brain structures and tissues, so it is crucial for diagnosing brain diseases. Compared with other imaging examinations, such as CT (Computed Tomography) or X-ray fluoroscopy, MRI examination is not only a non-invasive examination method, but also has less radiation issues. It uses magnetic fields and harmless radio waves to capture the image of brain tissue so as to produce high-resolution image, so that MRI is safer for patients. In addition, the radiation-free property of MRI is also suitable for long-term tracking of patients, especially for patients who require repeated examinations, such as patients with epilepsy or multiple sclerosis. Therefore, MRI can be used not only for diagnosis, but also for improving monitoring of treatment effects, accelerating assessment of disease progression, etc. For example, for patients with brain tumors, MRI can be used to detect the size, location and blood supply of the tumor and track changes after treatment.

Generally speaking, after a patient undergoes an MRI scan, medical professionals, such as radiologists, then need to perform manual judgment and interpretation on the obtained MRI images. This manual judgment and interpretation is to evaluate whether the structures and tissues of various regions of the brain are normal or not based on the MRI images, thereby checking is there any abnormalities in the brain images. Based on the interpretation of MRI images, doctors can diagnose various brain diseases, including, for example but not limited to, tumors, stroke, cerebral hemorrhage, multiple sclerosis, epilepsy, and the likes. Furthermore, based on the abnormal features in MRI images, the type, location and progression of the disease can be further determined. However, the large amount of imaging data generated by MRI examination requires radiologists to spend a lot of time to make an accurate diagnosis, which may cause patients to wait for a long time for the doctor's diagnostic reports, thereby delaying the progress of treatment.

Taking the neuroradiology department of a general hospital as an example, an average of about 500 medical images can be obtained in the brain MRI examination for each patient. Assuming 50 patients undergoing the brain MRI examination per day, there will be nearly 25,000 MRI images a day requiring manual medical diagnosis by radiologists. This results in patients having to wait one to two weeks on average before receiving a diagnostic report, which may miss the best opportunity for treatment.

In recent years, with the development of artificial intelligence in medical imaging, the artificial intelligence solutions to determine whether brain images are normal or abnormal have been highly considered. However, although image-based artificial intelligence model training is relatively fast, it still requires long-term learning of disease characteristics to obtain the lesions as a basis for identification and judgment. So far, the most common artificial intelligence models mostly use a forward list method to make judgments and identifications. This kind of discrimination model is prone to uncertainty or identification doubts for lesions in special locations. In addition, since the detailed data contained in one single DICOM (Digital Imaging and Communications in Medicine) image is quite large and complex, it greatly affects the system analysis and calculation time. In other words, no matter how fast it is to use the conventional medical imaging artificial intelligence models for interpretation, it takes tens of seconds to several minutes on average.

Therefore, it is desired to improve diagnostic efficiency and provide a more clinically efficient tool to help radiologists screen images, so that they can more quickly identify normal and abnormal tissues in brain medical images, thereby saving radiologists time in reviewing images, allowing them to have more time to focus on cases that require more in-depth research, and thus providing patients with better quality medical care.

### SUMMARY

An objective of this disclosure is to provide a method and system of brain imaging detection that can quickly screen out abnormal brain images, and increase the speed of analyzing a large number of images, thereby quickly prioritizing on the cases with structural abnormalities.

To achieve the above, a method of brain imaging detection of this disclosure includes the following steps of: dividing a brain image into a left brain medical image and a right brain medical image and obtaining grayscale values of a plurality of pixels of the left brain medical image and the right brain medical image, respectively; mirror-flipping one of the left brain medical image and the right brain medical image; performing a grayscale value subtraction with the mirror-flipped medical image and the other medical image to obtain a plurality of grayscale differences of the pixels; determining whether the grayscale difference of each of the pixels exceeds a grayscale difference threshold; determining whether a number of the pixels having the grayscale different exceeding the grayscale difference threshold is greater than or equal to a pixel number threshold; and when the number of the pixels having the grayscale difference exceeding the grayscale difference threshold is greater than or equal to the pixel number threshold, determining that the brain image is abnormal.

In one embodiment, the brain image is a 2D brain image.

In one embodiment, the method of brain imaging detection includes a step of: when the brain image is a 3D brain image, performing a braincase removal with the 3D brain image.

In one embodiment, the method of brain imaging detection includes steps of: dimensionally reducing the 3D brain image into one or more 2D brain images; and performing a black edge removal with the one or more 2D brain images.

In one embodiment, when a sum of the numbers of the pixels, in at least one or more of the 2D brain images, having the grayscale difference exceeding the grayscale difference threshold is greater than or equal to the pixel number threshold, determining that the brain image is abnormal.

In one embodiment, the brain image is a DWI brain image, a DTI brain image, a T1 brain image, or a T2 brain image.

In one embodiment, the step of performing the grayscale value subtraction with the mirror-flipped medical image and the other medical image to obtain the plurality of grayscale differences of the pixels includes to perform the grayscale value subtraction with one or more pixel areas in the mirror-flipped medical image and the other medical image to obtain the plurality of grayscale differences of the pixels in the one or more pixel areas.

In one embodiment, the plurality of grayscale differences are obtained as absolute values.

In one embodiment, the grayscale difference threshold ranges from 190 to 210, and the pixel number threshold ranges from 10 to 12.

In one embodiment, the grayscale difference threshold is 200, and the pixel number threshold is 11.

To achieve the above, a system of brain imaging detection of this disclosure includes a medical imaging module, an operation module, a subtraction module, and a comparison module. The medical imaging module is electrically or communicational connected to the operation module, the subtraction module and the comparison module. The medical imaging module divides a brain image into a left brain medical image and a right brain medical image and obtains grayscale values of a plurality of pixels of the left brain medical image and the right brain medical image, respectively. The operation module mirror-flips one of the left brain medical image and the right brain medical image. The subtraction module performs a grayscale value subtraction with the mirror-flipped medical image and the other medical image to obtain a plurality of grayscale differences of the pixels. The comparison module determines whether the grayscale difference of each of the pixels exceeds a grayscale difference threshold, and determines whether a number of the pixels having the grayscale different exceeding the grayscale difference threshold is greater than or equal to a pixel number threshold. When the number of the pixels having the grayscale difference exceeding the grayscale difference threshold is greater than or equal to the pixel number threshold, the brain image is determined as abnormal.

In one embodiment, the brain image is a 2D brain image.

In one embodiment, when the brain image is a 3D brain image, the medical imaging module performs a braincase removal with the 3D brain image.

In one embodiment, the medical imaging module dimensionally reduces the 3D brain image into one or more 2D brain images, and performs a black edge removal with the one or more 2D brain images.

In one embodiment, when a sum of the numbers of the pixels, in at least one or more of the 2D brain images, having the grayscale difference exceeding the grayscale difference threshold is greater than or equal to the pixel number threshold, the brain image is determined as abnormal.

In one embodiment, the brain image is a DWI brain image, a DTI brain image, a T1 brain image, or a T2 brain image.

In one embodiment, the medical imaging module retrieves one or more pixel areas in the mirror-flipped medical image and the other medical image, and the subtraction module performs the grayscale value subtraction with the one or more pixel areas in the mirror-flipped medical image and the other medical image to obtain the plurality of grayscale differences of the pixels in the one or more pixel areas.

In one embodiment, the subtraction module obtains absolute values of the plurality of grayscale differences. In one embodiment, the grayscale difference threshold is 200, and the pixel number threshold is 11.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a flow chart of a method of brain imaging detection according to an embodiment of this disclosure;

FIG. 1A is a schematic diagram showing the evaluation metrics curves of the method of brain imaging detection according to the embodiment of this disclosure;

FIG. 2 is a flow chart of another method of brain imaging detection according to an embodiment of this disclosure;

FIG. 2A is a schematic diagram showing a 2D brain image;

FIG. 2B is a schematic diagram showing the 2D brain image processed with a black edge removal and a braincase removal;

FIG. 2C is a schematic diagram showing a mirror-flipped left brain medical image;

FIG. 2D is a schematic diagram showing a right brain medical image;

FIG. 2E is a schematic diagram showing an overlapping of FIG. 2C and FIG. 2D; and

FIG. 3 is a schematic diagram showing a system of brain imaging detection according to an embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

It should be noted that the brain is one of the most important organs in the human body, and its importance is indescribable. As the core of central nervous system, the brain is not only responsible for controlling and coordinating various physiological and psychological activities of human body, but also responsible for perception and sensation to process and interpret sensory information from the outside and the inside, including vision, hearing, touch, taste and smell, etc. When it comes to brain disease diagnosis, monitoring, trauma assessment, and scientific research, MRI (Magnetic Resonance Imaging) is often chosen for these operations. From a brain structure perspective, the two sides (left and right sides) of the brain are anatomically symmetrical. There are many structures and areas between the two sides of the brain, such as frontal lobes, parietal lobes, lateral lobes, etc., which are roughly the same sizes and shapes. This structural symmetry is the result of genes and physiological mechanisms during brain development. This application uses the grayscale differences in specific areas of the left brain medical image and the right brain medical image to determine that whether the brain images is abnormal or not.

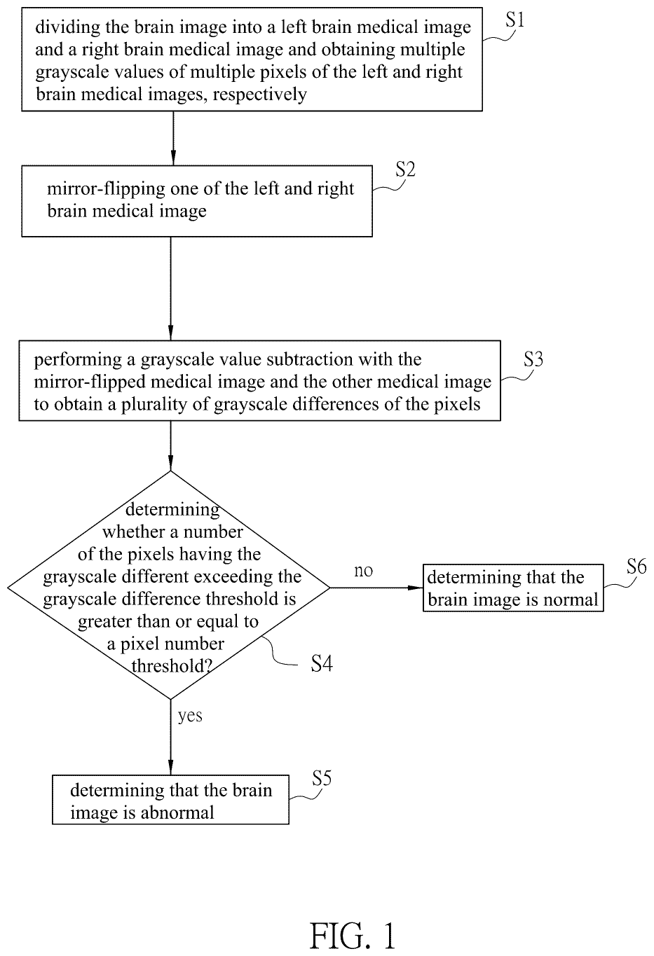

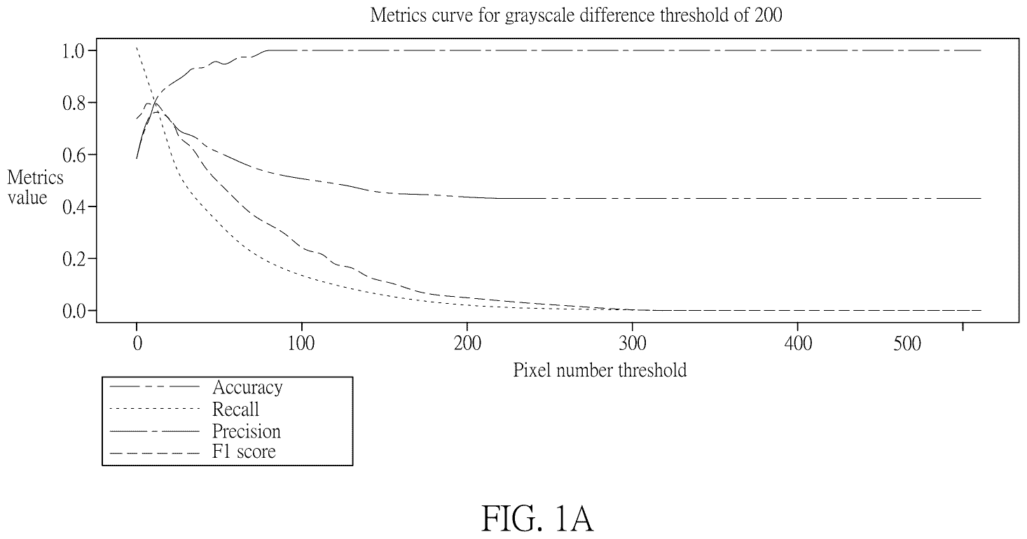

Referring to FIG. 1, in the method of brain imaging detection of this embodiment, the step S1 is to divide the brain image into a left brain medical image and a right brain medical image and to obtain multiple grayscale values of multiple pixels of the left and right brain medical images, respectively. Specifically, the patient's 3D brain image is first acquired by an MRI scanner, and then the 3D brain image is processed by the PACS system (Picture Archiving and Communication System). For example, a 3D brain image can be processed with a braincase removal (i.e., removing the braincase image), and then the 3D brain image can be dimensionally reduced to one or more 2D brain images. Herein, the dimensionality reduction can performed by transforming the 3D image to the 2D image(s), or by using mathematical operations. In addition, the method of brain imaging detection of this embodiment may further include a step of performing a black edge removal with the one or more 2D brain images, which is to remove the redundant black edges. Afterwards, the 2D brain image, which is performed with the braincase removal and the black edge removal, may be divided into a left brain medical image and a right brain medical image, and the left brain medical image and a right brain medical image are analyzed to obtain grayscale values of a plurality of pixels of the left brain medical image and the right brain medical image, respectively. Generally speaking, the structures of the left and right brains are symmetrical. Therefore, when the overall difference between the multiple grayscale values of multiple pixels of the left brain medical image and the multiple grayscale values of multiple pixels of the right brain medical image is low, it means that the brain image can be determined as normal. In other words, when the overall difference between the multiple grayscale values of multiple pixels of the left brain medical image and the multiple grayscale values of multiple pixels of the right brain medical image in one or more specific areas is high, it means that the brain image can be determined as abnormal.

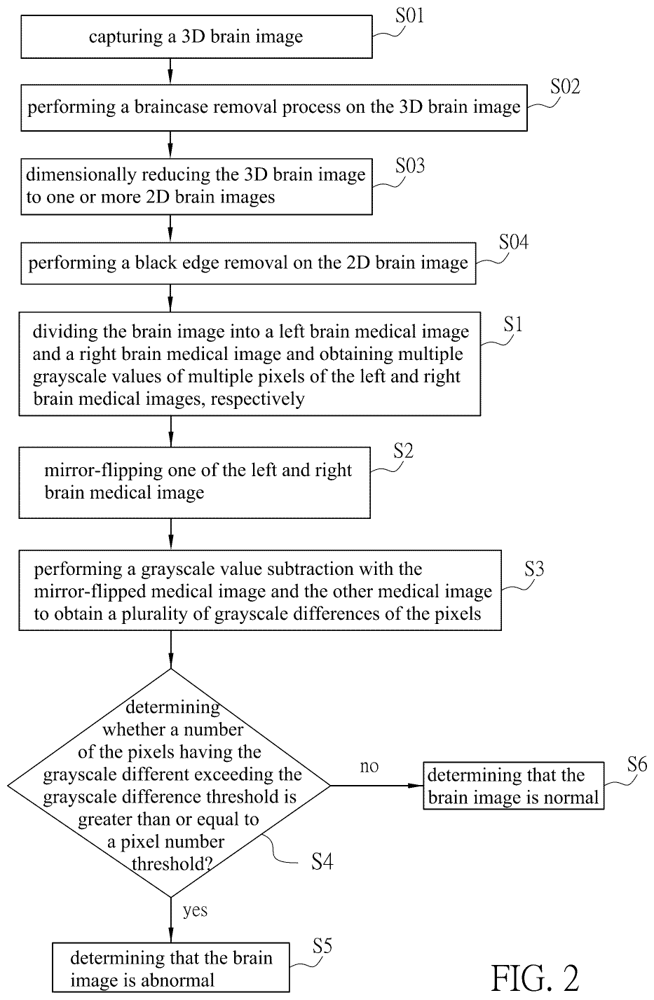

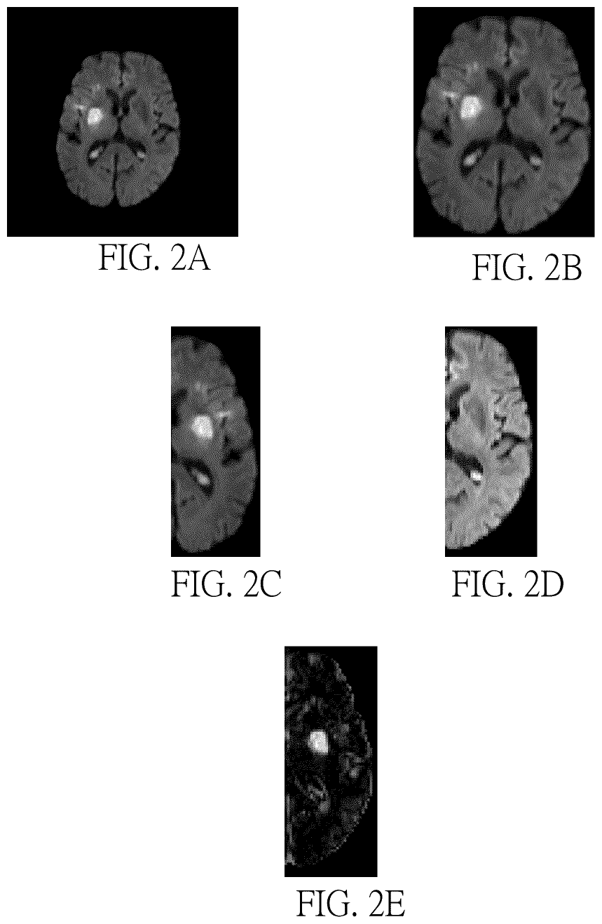

Referring to FIG. 1 and FIGS. 2A-2E, the step S2 is to mirror-flip one of the left and right brain medical images. In this embodiment, the left brain medical image can be mirror-flipped (first flip mode) to obtain the mirror-flipped left brain medical image as shown in FIG. 2C. In other embodiments, the right brain medical image can be mirror-flipped (second flip mode) (not shown). This embodiment adopts the first flip mode. Next, the step S3 is to perform a grayscale value subtraction with the mirror-flipped medical image (e.g. the mirror-flipped left brain medical image) and the other medical image (e.g. the right brain medical image) to obtain a plurality of grayscale differences of the pixels. Since the structures of the left and right brains are symmetrical, the grayscale values of the pixels in one or more pixel areas in the mirror-flipped image can be captured and subtracted with the grayscale values of the pixels in corresponding one or more pixel areas in the other image respectively so as to obtain a plurality of grayscale differences of the pixels. Specifically, the multiple grayscale values of multiple pixels in one or more pixel areas in the mirror-flipped left brain medical image are subtracted with the multiple grayscale values of multiple pixels in the corresponding pixel areas in the right brain medical image so as to obtain a plurality of grayscale differences of the pixels. For example, the mirror-flipped left brain medical image as shown in FIG. 2C can be overlapped with the right brain medical image as shown in FIG. 2D, and then the grayscale values of corresponding pixels in the two images are subtracted so as to obtain the image as shown in FIG. 2E. Herein, FIG. 2E represents the results of multiple grayscale differences of multiple pixels. In other embodiments, the multiple grayscale values of multiple pixels in one or more pixel areas in the mirror-flipped right brain medical image can be subtracted with the multiple grayscale values of multiple pixels in the corresponding pixel areas in the left brain medical image so as to obtain a plurality of grayscale differences of the pixels. The calculation of each grayscale difference can be the absolute value of the subtraction result. For example, the corresponding one or more pixel areas may be located in specific areas such as the frontal lobe, parietal lobe, and/or lateral lobe. Subsequently, the one or more pixel areas in the mirror-flipped image and the other image can be determined as normal or abnormal based on the absolute values of the multiple grayscale differences of the multiple pixels in these pixel areas.

As mentioned above, the 2D brain image is divided into a left brain image and a right brain image, the left brain image or the right brain image is mirror-flipped, and a grayscale value subtraction is performed with the grayscale values of pixels of the mirror-flipped brain image and the other brain image so as to obtain (the absolute value of) the grayscale differences of the two brain images. Each of the grayscale differences is between 0 and 255. Herein, the greater the grayscale difference, the greater the difference between the grayscale values in the pixels of the left and right brain images, which also represents that a pixel area can be determined as abnormal.

Referring to FIG. 1 and FIG. 1A, the step S4 is to determine whether the grayscale difference of each of the pixels exceeds a grayscale difference threshold, and to determine whether a number of the pixels having the grayscale different exceeding the grayscale difference threshold is greater than or equal to a pixel number threshold. To be noted, there may be a variation on the grayscale difference threshold that is used to determine each pixel as abnormal. Therefore, it is desired to utilize statistical analysis to find a preferred grayscale difference threshold that can judge each pixel as abnormal to filter out the grayscale differences, which can truly distinguish the normal and abnormal pixels in the brain image. In addition, it is also desired to find a pixel number threshold for the total number of the pixels determined as abnormal, so as to filter out the number of abnormal pixels that can truly distinguish abnormal cases in specific areas of the brain image. In the process of searching for these two thresholds to distinguish normal and abnormal cases, it is reasonable to calculate and analyze the factors of evaluation metrics, such as Accuracy, Recall, Precision and F1 score, to search for the optimal grayscale difference threshold and the pixel number threshold. In other words, the data shown in the following evaluation metrics table can be used as the references to search for these two thresholds, including the grayscale difference threshold and the pixel number threshold, to distinguish normal and abnormal images. The evaluation metrics table is as follows:

Evaluation metrics table

| Grayscale | Pixel | | | | |
|---|---|---|---|---|---|
| difference | number | | | | |
| threshold | threshold | Accuracy | Recall | Precision | F1 score |
| 190 | 10 | 0.686957 | 0.922013 | 0.664551 | 0.772392 |
| 190 | 11 | 0.694928 | 0.909434 | 0.67444 | 0.774505 |
| 190 | 12 | 0.707246 | 0.896855 | 0.688889 | 0.779235 |
| 200 | 10 | 0.75942 | 0.792453 | 0.790464 | 0.791457 |
| 200 | 11 | 0.767391 | 0.777358 | 0.811024 | 0.793834 |
| 200 | 12 | 0.763043 | 0.759748 | 0.816216 | 0.786971 |
| 210 | 10 | 0.716667 | 0.583648 | 0.885496 | 0.703563 |
| 210 | 11 | 0.700725 | 0.545912 | 0.893004 | 0.677596 |
| 210 | 12 | 0.692754 | 0.52327 | 0.902386 | 0.66242 |

As shown in FIG. 1 and FIG. 1A, when the number of pixels having the grayscale difference(s) exceeding the grayscale difference threshold is greater than or equal to the pixel number threshold, the step S5 is to determine that the brain image is abnormal. In addition, when the number of pixels having the grayscale difference(s) exceeding the grayscale difference threshold is less than the pixel number threshold, the step S6 is to determine that the brain image is normal. Furthermore, when in at least one or more 2D brain images, the sum of the numbers of pixels having the grayscale differences exceeding the grayscale difference threshold is greater than or equal to the pixel number threshold, the brain image is determined as abnormal. In this case, the at least one or more 2D brain images can combine to form a 3D brain image. It can be found from the evaluation metrics table that the grayscale difference threshold ranges from 190 to 210, and the pixel number threshold ranges from 10 to 12. Preferably, when the grayscale difference threshold is 200 and the pixel number threshold is 11, Accuracy is the highest value of 0.767391, which serves as a basis for searching for the best grayscale difference threshold and pixel number threshold. In other words, a grayscale difference threshold can be found for the resulted image of the subtraction process with the mirror-flipped medical image and the other medical image, wherein the pixels in the resulted image having the grayscale difference exceeding the grayscale difference threshold are determined as abnormal. Then, if the number of the pixels having the grayscale difference exceeding the grayscale difference threshold is greater than or equal to the pixel number threshold, the current case (the brain image) is determined as abnormal. As mentioned above, when the grayscale difference threshold is 200 and the pixel number threshold is 11, there will be optimized Accuracy, Recall, Precision and F1 score. FIG. 1A shows that the maximum benefit can be achieved when the pixel number threshold is 11.

Please refer to FIG. 1 and FIG. 2. FIG. 2 is a flow chart of another method of brain imaging detection according to an embodiment of this disclosure, which includes steps S01 to S04 and steps S1 to S6, wherein steps S1 to S6 can refer to the previous embodiment, so the detailed description thereof will be omitted. In this embodiment, the step S01 is to capture a 3D brain image. This application uses a detection method to quickly determine whether the brain image is abnormal or normal based on the difference in left and right brain images. In this embodiment, the brain image may be a DWI (Diffusion weighted imaging) brain image, a DTI (Diffusion tensor imaging) brain image, a T1 brain image, or a T2 brain image. The step S02 is to perform a braincase removal process on the 3D brain image. Next, the step S03 is to dimensionally reduce the 3D brain image to one or more 2D brain images (as shown in FIG. 2A). For example, after the PACS system receives the 3D DWI brain image, the 3D DWI brain image can be sliced from top to bottom into a series of 2D brain images. Then, the step S04 is to perform a black edge removal on the 2D brain image (as shown in FIG. 2B). For the original 3D brain image, the following processes of braincase removal to the 3D brain image and the black edge removal to the 2D brain image can ensure that the image focuses on the brain itself. Therefore, the 2D sliced brain image after the braincase removal and the black edge removal can be extracted, thereby further extracting the left and right brain images with obvious grayscale differences in specific pixel areas.

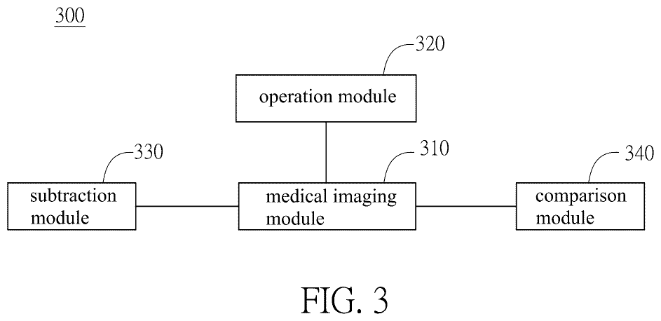

Referring to FIG. 3, a system of brain imaging detection 300 of the present disclosure includes a medical imaging module 310, an operation module 320, a subtraction module 330, and a comparison module 340. The medical imaging module 310 is electrically connected to the operation module 320, the subtraction module 330 and the comparison module 340. For example, the medical imaging module 310 can be a PACS system (Picture Archiving and Communication System), and the operation module 320 can be a tablet computer, a notebook computer or a desktop computer. The operation module 320 can be any suitable calculator, and this disclosure is not limited. The subtraction module 330 can be a subtractor, and the comparison module 340 can be a comparator.

The medical imaging module 310 divides the brain image into a left brain medical image and a right brain medical image, and obtains the grayscale values of a plurality of pixels of the left brain medical image and the right brain medical image, respectively. The operation module 320 mirror-flips one of the left brain medical image and the right brain medical image. The subtraction module 330 performs a grayscale value subtraction with the mirror-flipped medical image and the other medical image to obtain a plurality of grayscale differences of the pixels. The comparison module 340 determines whether the grayscale difference of each of the pixels exceeds a grayscale difference threshold, and determines whether a number of the pixels having the grayscale different exceeding the grayscale difference threshold is greater than or equal to a pixel number threshold. When the number of the pixels having the grayscale difference exceeding the grayscale difference threshold is greater than or equal to the pixel number threshold, the brain image is determined as abnormal. When the number of the pixels having the grayscale difference exceeding the grayscale difference threshold is less than the pixel number threshold, the brain image is determined as normal.

In one embodiment, the brain image can be a 2D brain image.

In one embodiment, when the brain image is a 3D brain image, the medical imaging module 310 performs a braincase removal with the 3D brain image.

In one embodiment, the medical imaging module 310 dimensionally reduces the 3D brain image into one or more 2D brain images, and performs a black edge removal with the one or more 2D brain images.

In one embodiment, when a sum of the numbers of the pixels, in at least one or more of the 2D brain images, having the grayscale difference exceeding the grayscale difference threshold is greater than or equal to the pixel number threshold, the brain image is determined as abnormal.

In one embodiment, the brain image is a DWI brain image, a DTI brain image, a T1 brain image, or a T2 brain image.

In one embodiment, the medical imaging module 310 retrieves one or more pixel areas in the mirror-flipped medical image and the other medical image, and the subtraction module 330 performs the grayscale value subtraction with the one or more pixel areas in the mirror-flipped medical image and the other medical image to obtain a plurality of grayscale differences of the pixels in the one or more pixel areas.

In one embodiment, the subtraction module 330 obtains absolute values of the plurality of grayscale differences. In one embodiment, the grayscale difference threshold is 200, and the pixel number threshold is 11.

In summary, the present disclosure provides a method and system of brain imaging detection that can quickly screen out abnormal brain images, effectively improve the speed of analyzing a large number of brain images, and search for the optimum grayscale difference threshold and pixel number threshold based on the evaluation metrics table. Therefore, the brain images with structural abnormalities can be quickly prioritized, and the operation is easy, fast and accurate.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A method of brain imaging detection, comprising steps of:
dividing a brain image into a left brain medical image and a right brain medical image and obtaining grayscale values of a plurality of pixels of the left brain medical image and the right brain medical image, respectively;
mirror-flipping one of the left brain medical image and the right brain medical image;
performing a grayscale value subtraction with the mirror-flipped medical image and the other medical image to obtain a plurality of grayscale differences of the pixels;
determining whether the grayscale difference of each of the pixels exceeds a grayscale difference threshold;
determining whether a number of the pixels having the grayscale different exceeding the grayscale difference threshold is greater than or equal to a pixel number threshold; and
when the number of the pixels having the grayscale difference exceeding the grayscale difference threshold is greater than or equal to the pixel number threshold, determining that the brain image is abnormal.

2. The method of claim 1, wherein the brain image is a 2D brain image.

3. The method of claim 2, wherein when a sum of the numbers of the pixels, in at least one or more of the 2D brain images, having the grayscale difference exceeding the grayscale difference threshold is greater than or equal to the pixel number threshold, determining that the brain image is abnormal.

4. The method of claim 1, further comprising a step of:
when the brain image is a 3D brain image, performing a braincase removal with the 3D brain image.

5. The method of claim 1, further comprising a step of:
dimensionally reducing the 3D brain image into one or more 2D brain images; and
performing a black edge removal with the one or more 2D brain images.

6. The method of claim 5, wherein when a sum of the numbers of the pixels, in at least one or more of the 2D brain images, having the grayscale difference exceeding the grayscale difference threshold is greater than or equal to the pixel number threshold, determining that the brain image is abnormal.

7. The method of claim 1, wherein the brain image is a DWI brain image, a DTI brain image, a T1 brain image, or a T2 brain image.

8. The method of claim 1, wherein the step of performing the grayscale value subtraction with the mirror-flipped medical image and the other medical image to obtain the plurality of grayscale differences of the pixels comprises to perform the grayscale value subtraction with one or more pixel areas in the mirror-flipped medical image and the other medical image to obtain the plurality of grayscale differences of the pixels in the one or more pixel areas.

9. The method of claim 1, wherein the plurality of grayscale differences are obtained as absolute values.

10. The method of claim 1, wherein the grayscale difference threshold ranges from 190 to 210, and the pixel number threshold ranges from 10 to 12.

11. The method of claim 10, wherein the grayscale difference threshold is 200, and the pixel number threshold is 11.

12. A system of brain imaging detection, comprising:
a medical imaging module dividing a brain image into a left brain medical image and a right brain medical image and obtaining grayscale values of a plurality of pixels of the left brain medical image and the right brain medical image, respectively;
an operation module mirror-flipping one of the left brain medical image and the right brain medical image;
a subtraction module performing a grayscale value subtraction with the mirror-flipped medical image and the other medical image to obtain a plurality of grayscale differences of the pixels; and
a comparison module determining whether the grayscale difference of each of the pixels exceeds a grayscale difference threshold, and determining whether a number of the pixels having the grayscale different exceeding the grayscale difference threshold is greater than or equal to a pixel number threshold;
wherein, the medical imaging module is electrically or communicational connected to the operation module, the subtraction module and the comparison module; and when the number of the pixels having the grayscale difference exceeding the grayscale difference threshold is greater than or equal to the pixel number threshold, the brain image is determined as abnormal.

13. The system of claim 12, wherein the brain image is a 2D brain image.

14. The system of claim 13, wherein when a sum of the numbers of the pixels, in at least one or more of the 2D brain images, having the grayscale difference exceeding the grayscale difference threshold is greater than or equal to the pixel number threshold, that the brain image is determined as abnormal.

15. The system of claim 12, wherein when the brain image is a 3D brain image, the medical imaging module performs a braincase removal with the 3D brain image.

16. The system of claim 15, wherein the medical imaging module dimensionally reduces the 3D brain image into one or more 2D brain images, and performs a black edge removal with the one or more 2D brain images.

17. The system of claim 16, wherein when a sum of the numbers of the pixels, in at least one or more of the 2D brain images, having the grayscale difference exceeding the grayscale difference threshold is greater than or equal to the pixel number threshold, the brain image is determined as abnormal.

18. The system of claim 12, wherein the brain image is a DWI brain image, a DTI brain image, a T1 brain image, or a T2 brain image.

19. The system of claim 12, wherein the medical imaging module retrieves one or more pixel areas in the mirror-flipped medical image and the other medical image, and the subtraction module performs the grayscale value subtraction with the one or more pixel areas in the mirror-flipped medical image and the other medical image to obtain the plurality of grayscale differences of the pixels in the one or more pixel areas.

20. The system of claim 12, wherein the subtraction module obtains absolute values of the plurality of grayscale differences; and wherein the grayscale difference threshold is 200, and the pixel number threshold is 11.
